(19) United States
(12) Patent Application Publication
(10) Pub. No.: US 2024/0408722 A1
(43) Pub. Date: Dec. 12, 2024

(54) MATERIAL COLLECTION DEVICE, SUPPORT ELEMENT, COVER UNIT AND MACHINE TOOL

(71) Applicant: Robert Bosch GmbH, Stuttgart (DE)

(72) Inventors: Florian Esenwein, Leinfelden-Echterdingen (DE); Pim van Dommelen, Tilburg (NL)

(21) Appl. No.: 18/732,781

(22) Filed: Jun. 4, 2024

(30) Foreign Application Priority Data
Jun. 9, 2023 (DE) 10 2023 205 362.4

(51) Int. Cl. B24B 55/10

(52) U.S. Cl. CPC B24B 55/10

(57) ABSTRACT

A material collection device for a machine tool, in particular for a sanding machine, includes at least one filter element, having a support element arranged in a mounted state within the filter element for clamping the filter element and having a, in particular rigid, filter protective cover, which has at least one air outlet opening. The filter element is arranged in the filter protective cover in the mounted state.

### PRIOR ART

Various material collection devices for machine tools have already been proposed.

### DISCLOSURE OF THE INVENTION

A material collection device for a machine tool, in particular for a sanding machine, having at least one filter element, having a support element arranged in a mounted state within the filter element for clamping the filter element and having a, in particular rigid, filter protective cover, which has at least one air outlet opening, wherein the filter element is arranged in the filter protective cover in the mounted state, is proposed.

The design of the material collection device according to the invention can provide a particularly high level of protection for the filter element. A particularly durable material collection device may be provided. A particularly high level of dimensional stability of the filter element can be achieved in an advantageous manner. Advantageously, dust sticking to the filter material can be counteracted. Advantageously, clogging of the filter can be counteracted. Particularly efficient filtering can be realized. The filter element can be cleaned by tapping it over the filter protective cover. Advantageously, the filter can be cleaned particularly easily and/or efficiently. A particularly high level of operating convenience can be achieved.

The material collection device is in particular provided for collecting material that is mechanically separated and/or removed from a workpiece by the machine tool. The material may in particular be dust, chips, abraded material, or the like. “Provided” is understood in particular as meaning specifically adapted, specifically programmed, specifically designed and/or specifically equipped. In particular, the phrase “an object being provided for a specific function” is intended to mean that the object fulfills and/or performs this specific function in at least one application state and/or operating state.

The machine tool is preferably configured as a hand-held machine tool, in particular as a sanding machine, preferably as an orbital sander or as a rotary sander, as a jigsaw, as an oscillating saw, as a drilling machine, as a milling machine, as a circular saw, as an angle sander, or as any other machine tool that appears to be useful to a person skilled in the art. The machine tool can preferably be held with one or two hands, in particular without a transport and/or holding device, and can be guided and operated by hand in particular during workpiece machining.

The filter protective cover is preferably cylindrical, in particular circular cylindrical, alternatively cuboid, frustoconical, pyramidal, or the like. Preferably, the filter protective cover comprises a plurality of air outlet openings. Preferably, the air outlet openings are at least partially different sizes. Preferably, a casing wall of the filter protective cover comprises at least a portion of the air outlet openings. It is also conceivable that at least the air outlet openings on the casing wall are the same size. The filter protection cover is provided in particular as a material collection container, preferably for the material filtered by the filter element.

The support element is in particular configured corresponding to the filter protective cover. The support element is preferably cylindrical, in particular circular cylindrical, alternatively cuboid, frustoconical, pyramidal, or the like. The support element is preferably provided to clamp the filter element in a state mounted on the support element, preferably at least largely without folds.

The filter element is preferably provided to filter the material, which is preferably mechanically separated and/or removed from a workpiece by the machine tool, from an air flow guided through the filter element. The filter element is in particular configured to be permeable to air. The filter element is in particular different from a pleated filter. Preferably, the filter element is configured as a filter without folds. For example, the filter element may be made of linter, cellulose, glass fiber, quartz fiber, fleece, a combination of these or another material that appears useful to a person skilled in the art.

The filter element can preferably be fastened to the support element. In particular, the support element comprises a fastening unit for fastening the filter element. Preferably, the filter element is detachable, in particular detachable without tools, from the support element, preferably by means of the fastening unit. In this context, the term “detachable” is in particular understood to mean “non-destructively separable”. The filter element can be securely fastened to the support element by means of the fastening unit of the support element, for example by means of a latching connection, a screw connection, a clamp connection, or the like. For example, the fastening unit of the support element comprises a retaining element, preferably a clamping ring, in particular made of metal, plastic, or the like, preferably an elastic material. In particular, a support element base body of the support element comprises a receptacle for receiving the retaining element. In the mounted state, the retaining element is preferably arranged in the receptacle. The retaining element is particularly provided to interact with the filter element and the receptacle of the support element base body to fasten the filter element to the support element. For example, the filter element is wrapped around the retaining element. It is also conceivable that the retaining element may be formed integrally with the filter element. The term “integral” is to be understood in particular to mean at least a materially bonded connection, for example, by a welding process, an adhesive bonding process, an injection molding process and/or another process that appears to the person skilled in the art to be reasonable, and/or advantageously formed in one piece, for example, by production from a casting and/or by production in a single-component or multi-component injection molding process and advantageously from a single blank.

Preferably, the filter element is at least substantially entirely surrounded by the filter protective cover in the mounted state when viewed in the radial direction. In particular, the filter element is entirely surrounded by the filter protective cover in the mounted state except for the at least one air outlet opening in the radial direction. The expression “at least substantially entirely” is understood to mean at least 50%, preferably at least 75%, and particularly preferably at least 90% of a total volume and/or a total mass of an object.

It is further proposed that the filter protective cover comprises a fastening unit for the secure arrangement of the filter element in the filter protective cover. Damage to the filter element as a result of the filter element accidently falling out of the filter protective cover may be advantageously counteracted. Advantageously, a material collection device with a particularly low risk of damage may be provided. A material collection device can be provided with a particularly high user comfort. The filter element is in particular detachable, preferably detachable without tools, from the filter protective cover, preferably by means of the fastening unit of the filter protective cover. In particular, the support element can be securely arranged in the filter protective cover by means of the fastening unit of the filter protective cover. Preferably, the fastening unit of the filter protective cover is provided to interact with the support element for the secure arrangement of the filter element in the filter protective cover. Alternatively or additionally, it is conceivable that the fastening unit of the filter protective cover is configured to directly interact with the filter element for the secure arrangement of the filter element in the filter protective cover. The filter element can be securely arranged in the filter protection cover by means of the fastening unit of the filter protective cover, for example by means of a latching connection, a screw connection, a clamp connection or the like. Preferably, the fastening unit of the filter protective cover comprises a thread, in particular an internal thread. Preferably, the support element comprises a mounting interface for fastening to, in particular in, the filter protective cover. The mounting interface of the support element is in particular provided to interact with the fastening unit of the filter protective cover for the secure arrangement of the filter element and/or the support element on, preferably in, the filter protective cover. The mounting interface of the support element is preferably configured corresponding to the fastening unit of the filter protective cover. The mounting interface of the support element preferably comprises a thread, in particular an external thread. The thread of the mounting interface of the support element is in particular provided to interact with the thread of the fastening unit of the filter protective cover in order to securely arrange the filter element and/or the support element in the filter protective cover.

Furthermore, it is proposed that the support element is rigid at least in the longitudinal direction. Advantageously, a deformation of the filter element, in particular at a negative pressure, can be easily and/or effectively counteracted in a constructive manner. A material collection device may be realized with a particularly dimensionally stable arrangement of the filter element. The formation of folds in the filter element can be counteracted particularly effectively and/or simply in terms of design. Advantageously, a filter element may be provided with a particularly high reliability. The support element is configured in particular such that the support element is free of deformation in the longitudinal direction in an operating state.

In addition, it is proposed that the support element comprises at least one support strut, which is configured to be tapered when viewed in a radial direction, in particular with respect to a main extension axis of the support element. Advantageously, a contact area between the filter element and the support element can be kept particularly low. A supported filter element having a particularly large effective filter area may be provided. Advantageously, a filter element can be realized with a particularly high efficiency. In particular, the support element comprises a plurality of support struts, for example two, three, four, five, six or more than six support struts. The support struts are preferably evenly arranged in the circumferential direction, which runs in particular in a plane perpendicular to the longitudinal direction and/or the main axis of extension, of the support element. A main extension axis of the at least one support strut runs at least substantially parallel to the longitudinal direction and/or the main extension axis of the support element. A “main extension axis” of an object can be understood in particular as an axis that extends parallel to a longest edge of a smallest geometric cuboid that just completely encloses the object, and in particular extends through the center of the cuboid. “Substantially parallel” can be understood here to mean an orientation of a direction relative to a reference direction, in particular in a plane, wherein the direction has a deviation relative to the reference direction that is in particular less than 8°, advantageously less than 5° and particularly advantageously less than 2°. The main extension axis of the support element runs preferably at least substantially parallel to the longitudinal direction of the support element. The at least one support strut is tapered laterally in the radial direction, preferably on both sides, particularly with regard to its main extension axis.

In addition, it is proposed that the filter protective cover comprises at least one air guide element configured as a recess. A particularly efficient air guide may advantageously be realized. Advantageously, a filter element having a particularly efficient filtering may be provided. Preferably, the air guide element is provided to direct an air flow towards the at least one air outlet opening of the filter protective cover. Preferably, an inner wall of the filter protective cover comprises the air guide element. Alternatively or additionally, it is also conceivable that the filter protective cover comprises at least one air guide element configured as a protrusion. It is conceivable that the air guide element may connect to the at least one air outlet opening. Alternatively, however, it is also conceivable that the air guide element is arranged spaced apart from the at least one air outlet opening.

Furthermore, it is proposed that the filter element is arranged spaced apart from the filter protective cover at least to a large extent in a state of the filter element arranged in the filter protective cover. Advantageously, an air flow through the filter element may be particularly efficiently directed to the at least one air outlet opening. Advantageously, a material collection device having particularly efficient filtering may be provided. The expression “to a large extent” should in particular be understood here to mean at least 55%, preferably at least 65%, preferably at least 75%, particularly preferably at least 85% and particularly preferably at most 95% of a volume and/or mass fraction. It is also conceivable that the entire filter element is arranged spaced apart from the filter protective cover when the filter element is arranged in the filter protective cover.

Furthermore, it is proposed that the support element is movable and/or deformable in the mounted state relative to the filter protective cover to generate impacts. Advantageously, a particularly efficient cleaning of the material collection device can be enabled. Dust sticking to the filter element may be particularly easily and/or efficiently constructively counteracted. Particularly efficient use of the filter element may be supported. Preferably, the support element has a free end when fastened in the filter protective cover. The free end is arranged, in particular at least in an unloaded state of the support element, preferably spaced apart from the filter protective cover. Preferably, the free end is movable relative to the filter protective cover, for example by shaking the filter protective cover. In particular, the free end is movable relative to the filter protective cover, such that a portion of the filter element arranged on the free end of the support element abuts the filter protective cover. Preferably, the support element is configured to be deflectable in a radial direction, preferably elastically.

Furthermore, it is proposed that the filter element comprises a dust-repellent coating. Advantageously, dust or the like sticking to the filter element can be particularly efficiently counteracted. The filter element can be used efficiently for a particularly long time. A particularly high level of user comfort can be achieved. Preferably, the filter element comprises a dust-repellent coating on at least one inner side. For example, the dust-repellent coating may be a polytetrafluorethylene coating, a polyether ether ketone coating, a polymethylurea coating, a nanofiber coating, a combination thereof, or the like. The dust-repellent coating is particularly provided to counteract dust, or the like, sticking.

In addition, the invention proceeds from a, in particular the aforementioned, support element for a, in particular the aforementioned, filter element of a, in particular the aforementioned, material collection device, for a, in particular the aforementioned, machine tool having a mounting unit for fastening the filter element. It is proposed that the support element comprises a, in particular the aforementioned, mounting interface, for fastening to, in particular in, a, preferably the aforementioned, filter protective cover. Damage to the filter element arranged on the support element as a result of the filter element accidently falling out of the filter protective cover may be advantageously counteracted.

In addition, a cover unit for a, in particular the aforementioned, material collection device for a, in particular the aforementioned, tool machine having a fastening unit for fastening a, in particular the aforementioned, support element for a, in particular the aforementioned, filter element and having a mounting interface for fastening a, in particular the aforementioned, filter protective cover, is proposed. The fastening unit of the cover unit is provided in particular for a, preferably additional, fixation of the support element to the filter protective cover. The fastening unit of the cover unit is configured here as a stop element, for example. Preferably, the stop element abuts the support element at least in one operating state. The stop element is provided in particular for a, in particular additional axial, fixation of the support element to the filter protective cover. Alternatively, however, it is also conceivable that the support element can be fastened to the cover unit by means of the fastening unit of the cover unit by means of a screw connection, a latching connection, a clamp connection, or the like, and/or can be fixed to the filter protective cover. Using the mounting interface of the cover unit, the cover unit can be fastened to the filter protective cover, for example by means of a screw connection, a latching connection, a clamp connection or the like. The mounting interface of the cover unit is preferably configured corresponding to the fastening unit of the filter protective cover. Preferably, the mounting interface of the cover unit comprises a thread, preferably an external thread, which is provided in particular for fastening the cover unit to the filter protective cover in order to interact with the thread of the filter protective cover. The cover unit particularly comprises a machine tool interface for fastening to the machine tool, in particular an ejection port of the machine tool. The cover unit preferably comprises a further mounting interface for the detachable, in particular tool-free detachable, fastening of a material disposal unit. The further mounting interface is preferably provided to fasten the material disposal unit to the cover unit instead of the filter protective cover. For example, the material disposal unit is a material collection container having at least one counter-interface compatible with the further mounting interface of the cover unit, in particular instead of a counter-interface compatible with the mounting interface of the cover unit. A counter-interface that is “compatible” with an interface is preferably to be understood as a functionally compatible counter-interface, which cooperates with the interface in order to enable a resilient fastening of two components to one another, in particular at least with respect to a dead weight of the components. For example, the material disposal unit can comprise a hose, in particular at least one hose nozzle, in particular configured as a vacuum cleaner having a counter-interface compatible with the further mounting interface, in particular instead of a counter-interface compatible with the mounting interface. The cover unit is preferably provided for a rigid connection of the machine tool to the filter protective cover or the material disposal unit, in particular at least a hose of the material disposal unit, in particular for an automatic entrainment of the filter protective cover or the material disposal unit, in particular at least a hose of the material disposal unit, during a movement of the machine tool. The cover unit is preferably provided to guide the material along an intended trajectory from the machine tool fastened to the cover unit by means of the machine tool interface, in particular the ejection port, to the filter protection cover fastened to the cover unit by means of the mounting interface or to the material disposal unit fastened to the cover unit by means of the further mounting interface of the cover unit. Along the provided trajectory, the cover unit preferably comprises an inlet opening for receiving the material from the machine tool and an outlet opening for ejecting the material from the cover unit, in particular into the filter protective cover or into the material disposal unit. The cover unit preferably comprises an, in particular annular, central wall, which bounds the outlet opening. The cover unit preferably comprises an outlet center axis that runs perpendicular to a main extension plane of the central wall. The outlet center axis preferably passes through a geometrical center of gravity of the central wall. A “main extension plane” of a structural unit should be understood to be a plane which is parallel to a largest side surface of a smallest notional cuboid which just completely encloses the structural unit, and in particular extends through the midpoint of the cuboid. The cover unit preferably comprises at least one fixation wall portion arranged on the central wall, on which the mounting interface of the cover unit is arranged. Preferably, the fixation wall portion is substantially circumferentially closed. The cover unit preferably comprises at least one, in particular the aforementioned or a further, fixation wall portion arranged on the central wall, on which the further mounting interface is arranged. The cover unit preferably comprises at least one machine tool-side wall portion arranged on the central wall, on which the machine tool interface is arranged. The at least one fixation wall portion, in particular all fixation wall portions, and the machine tool-side wall portion are preferably arranged on different sides of the central wall with respect to the outlet center axis. The cover unit in particular has an opening plane, which preferably runs perpendicular to the outlet center axis. The opening plane preferably limits an axial extension of the fixation wall portion, in particular of the further fixation wall portion, on which the further mounting interface is arranged. The cover unit preferably comprises a substantially closed, in particular the aforementioned further, fixing wall section in the circumferential direction. The further fixation wall portion in particular forms an air bypass. The air bypass is preferably formed by a recess of the further fixation wall portion that differs from the further mounting interface. With respect to the further mounting interface, the air bypass preferably has a minimum angular distance of greater than 15°, preferably greater than 30°, particularly preferably greater than 45°, in a plane perpendicular to the outlet center axis with the outlet center axis as the apex. With respect to the further mounting interface, the air bypass in particular has a minimum angular distance of less than 165°, preferably less than 150°, particularly preferably less than 135°, in a plane perpendicular to the outlet center axis as the apex. The air bypass and at least a majority of the machine tool interface or the complete machine tool interface are preferably arranged in different halves of the cover unit relative to at least one cutting plane comprising the outlet center axis. The air bypass is preferably formed by at least one, particularly preferably exactly one, slot-shaped air bypass recess of the fixation wall portion, in particular the further fixation wall portion. The air bypass recess preferably extends from the opening plane of the cover unit, starting at least substantially parallel to the outlet center axis. Particularly preferably, a maximum longitudinal extension of the air bypass recess parallel to the outlet center axis is greater than a maximum opening width of the air bypass recess in a plane perpendicular to the outlet center axis. Particularly preferably, a maximum longitudinal extension of the air bypass recess extends parallel to the outlet center axis over at least a substantial portion of a parallel maximum longitudinal extension of the, in particular, fixation wall portion. A “substantial portion” of a reference quantity is preferably understood to mean at least 25%, preferably at least 33%, particularly preferably at least 50% of the reference quantity. The air bypass recess has an opening width of less than 60°, preferably less than 45°, particularly preferably less than 35° in a plane perpendicular to the outlet center axis with respect to the outlet center axis. The air bypass preferably has an opening width of greater than 25°, preferably greater than 20°, particularly preferably greater than 15° in a plane perpendicular to the outlet center axis with respect to the outlet center axis.

Furthermore, a, in particular the aforementioned, machine tool, in particular a hand-held power tool, preferably a sanding machine, having a, in particular the aforementioned, material collection device, a, in particular the aforementioned, support element and/or a, in particular the aforementioned, cover unit, is proposed. Advantageously, ablation generated by the machine tool may be particularly efficiently and/or reliably extracted. A particularly high level of user comfort can advantageously be achieved.

The material collection device according to the invention, the support element according to the invention, the cover unit according to the invention and/or the machine tool according to the invention should not thereby be limited to the application and embodiment described above. In particular, the material collection device according to the invention, the support element according to the invention, the cover unit according to the invention and/or the machine tool according to the invention can have a number of individual elements, components and units that differ from a number specified herein in order to fulfill a mode of operation described herein. Moreover, regarding the ranges of values indicated in this disclosure, values lying within the limits specified hereinabove are also intended to be considered as disclosed and usable as desired.

### DRAWINGS

Further advantages follow from the description of the drawings hereinafter. An exemplary embodiment of the invention is shown in the drawing. The drawings, the description, and the claims contain numerous features in combination. A person skilled in the art will appropriately also consider the features individually and combine them into additional advantageous combinations.

### Shown are:

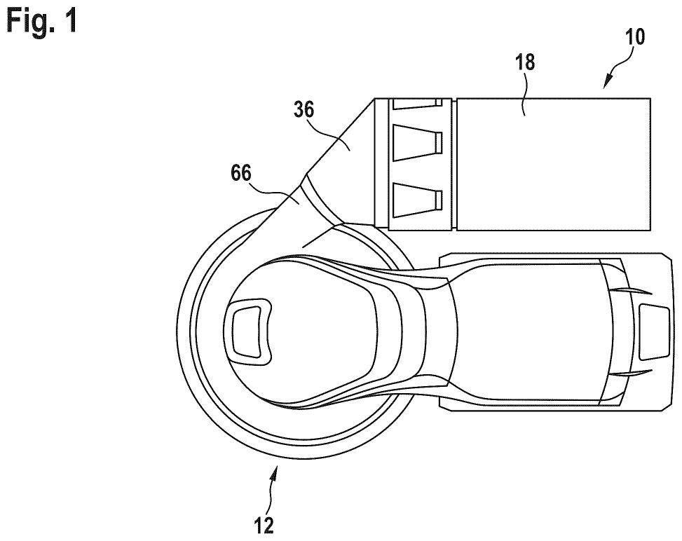

FIG. 1 a schematic illustration of a machine tool according to the invention having a material collection device according to the invention in a top plan view,

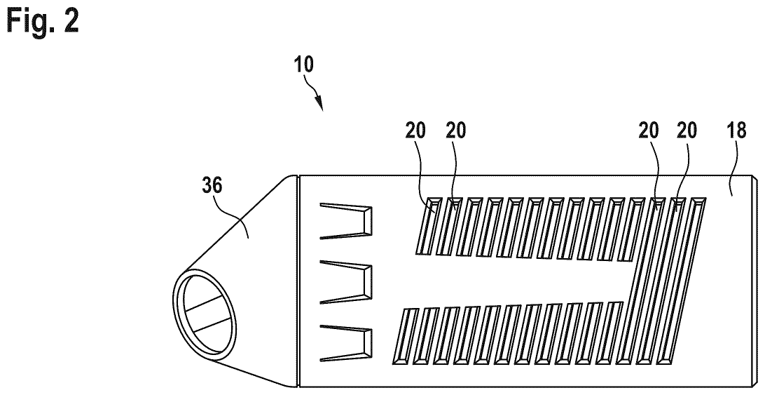

FIG. 2 the material collection device in a side view,

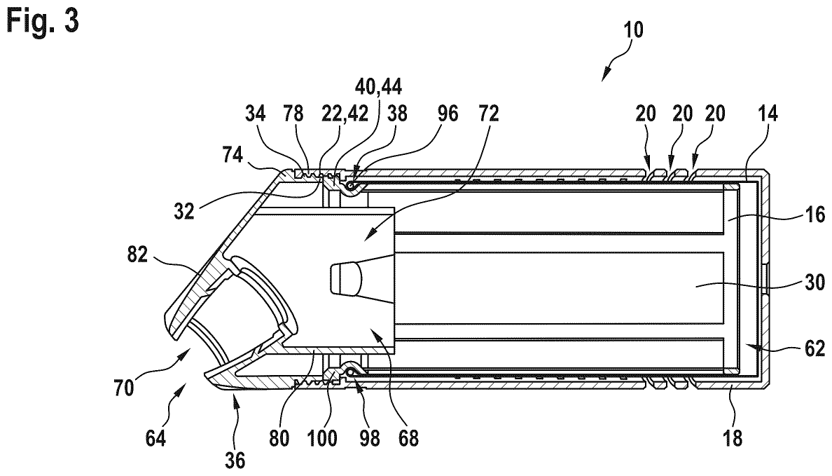

FIG. 3 the material collection device in a cross-sectional representation,

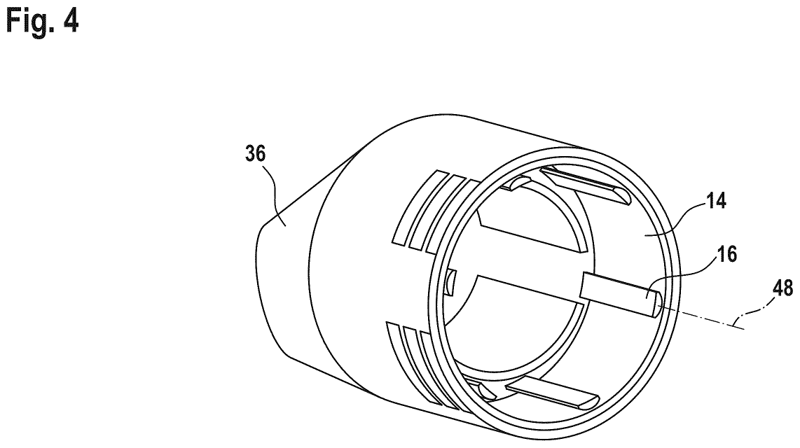

FIG. 4 the material collection device in a further cross-sectional representation,

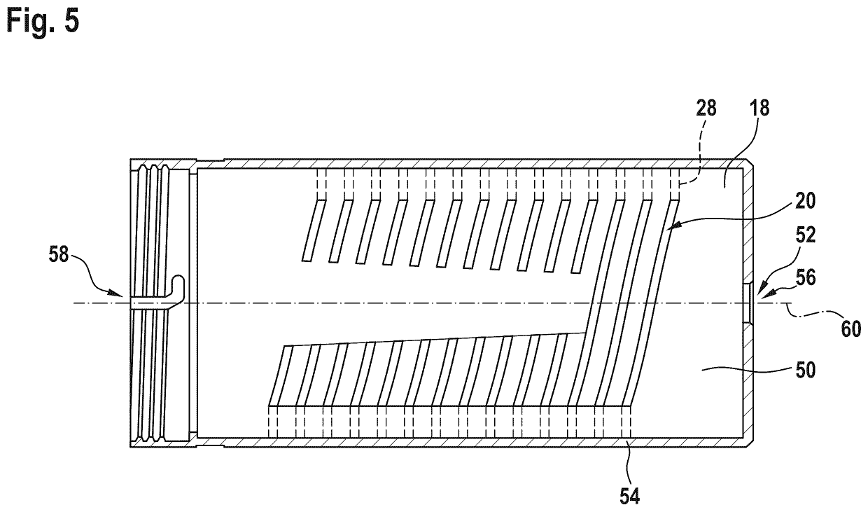

FIG. 5 a filter protective cover of the material collection device in a cross-sectional representation,

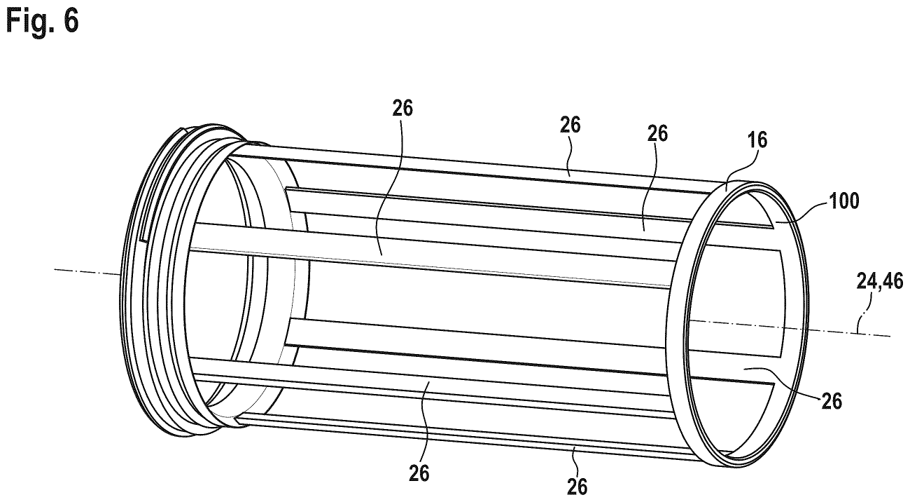

FIG. 6 a support element of the material collection device according to the invention in a perspective illustration,

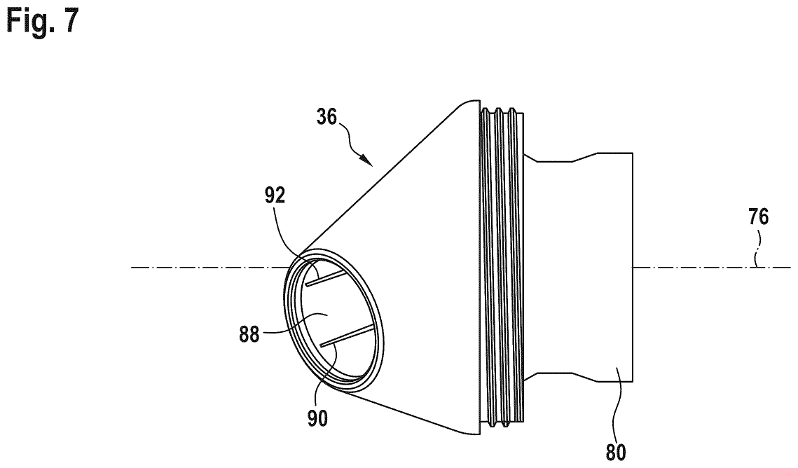

FIG. 7 a cover unit of the material collection device according to the invention in a side view, and

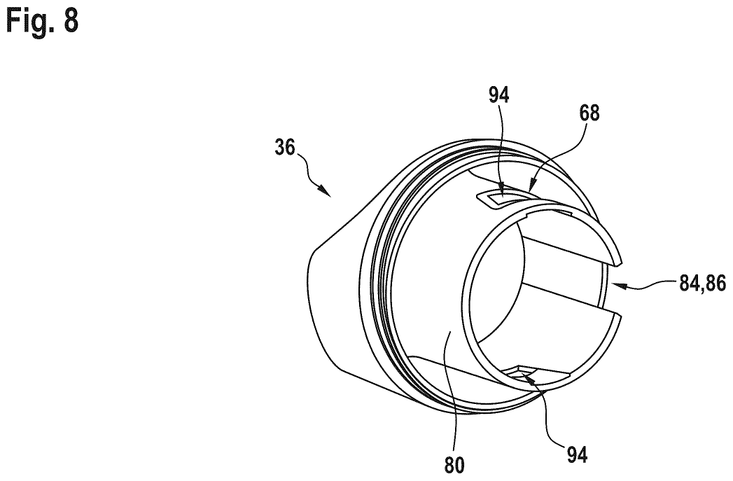

FIG. 8 the cover unit in a perspective view.

### DESCRIPTION OF THE EXEMPLARY EMBODIMENT

FIG. 1 shows a machine tool 12 having a material collection device 10. The machine tool 12 is configured as a hand-held power tool. As an example, the machine tool 12 is configured here as a sanding machine, in particular as a rotary sander or as an oscillating sander. Alternatively, it is also conceivable that the machine tool 12 is configured as a jigsaw, as an oscillating saw, as a drilling machine, as a milling machine, as a circular saw, as an angle sander, or as any other machine tool 12 that appears to be useful to a person skilled in the art. The machine tool 12 can preferably be held with one or two hands, in particular without a transport and/or holding device, and in particular be guided and operated by hand during workpiece machining.

The material collection device 10 is provided for collecting material that is mechanically separated and/or removed from a workpiece by the machine tool 12. The material may in particular be dust, chips, abraded material, or the like.

The material collection device 10 comprises a filter element 14. Alternatively, however, it is also conceivable that the material collection device 10 comprises more than one filter element 14, for example two filter elements 14, three filter elements 14 or more than three filter elements 14.

The filter element 14 is provided to filter the material, which is preferably mechanically separated and/or removed from a workpiece by the machine tool 12, from an air flow guided through the filter element 14. The filter element 14 is configured to be permeable to air. The filter element 14 is formed differently from a pleated filter. The filter element 14 is configured as a filter without folds. For example, the filter element 14 may be made of linter, cellulose, glass fiber, quartz fiber, fleece, a combination of these or another material that appears useful to a person skilled in the art.

The material collection device 10 comprises a support element 16 for clamping the filter element 14. In the mounted state, the support element 16 is arranged within the filter element 14. The filter element 14 can be fastened to the support element 16. The support element 16 comprises a fastening unit 38 for fastening the filter element 14. The filter element 14 is detachable, in particular detachable without tools, from the support element 16, preferably by means of the fastening unit 38. The support element 16 is provided to clamp the filter element 14 in a state mounted on the support element 16, preferably at least largely without folds.

The fastening unit 38 of the support element 16 comprises a retaining element, preferably a clamping ring 96, in particular made of metal, plastic, or the like, preferably an elastic material. A support element base body 100 of the support element 16 comprises a receptacle 98 for receiving the retaining element. In the mounted state, the retaining element is arranged in the receptacle. The retaining element is provided to interact with the filter element 14 and the receptacle 98 of the support element base body 100 to fasten the filter element 14 to the support element 16. The filter element 14 is wrapped around the retaining element at one end. It is also conceivable that the retaining element may be formed integrally with the filter element 14. Alternatively, however, it is also conceivable that the filter element 14 can be securely fastened to the support element 16 by means of the fastening unit 38 of the support element 16, for example by means of a latching connection, a screw connection, or the like.

The material collection device 10 comprises a filter protective cover 18. The filter protective cover 18 is cylindrical, in particular circular cylindrical. Alternatively, it is conceivable that the filter protective cover 18 may be cuboid, frustoconical, pyramidal, or the like.

The filter protective cover 18 is rigid. The filter protective cover 18 comprises a plurality of air outlet openings 20. Alternatively, however, it is also conceivable that the filter protective cover 18 only comprises one air outlet opening 20 or a different number of air outlet openings 20 from the number of air outlet openings 20 shown.

The air outlet openings 20 are arranged in a casing wall 54 of the filter protective cover 18. The casing wall 54 here has two sections with differently sized air outlet openings 20, by way of example. Alternatively, it is also conceivable that the air outlet openings 20 on the casing wall 54 are of the same size, or that the casing wall 54 comprises more than two sections with differently sized air outlet openings 20a. Preferably, a portion with air outlet openings 20, which are smaller than air outlet openings 20 of a further portion of the two portions, is arranged in the longitudinal direction 24 between the fastening unit 22 and the further portion. The filter protective cover 18 has at least one further air outlet opening 52. The further air outlet port 52 is arranged at an axial end 56 of the filter protective cover 18.

The support element 16 is configured corresponding to the filter protective cover 18. The support element 16 is cylindrical, in particular circular cylindrical. Alternatively, it is conceivable that the support element 16 may be cuboid, frustoconical, pyramidal, or the like.

The filter element 14 is arranged in the mounted state in the filter protective cover 18. The filter element 14 is at least substantially entirely surrounded by the filter protective cover 18 in the mounted state when viewed in the radial direction. The filter element 14 is entirely surrounded by the filter protective cover 18 in the mounted state except for the air outlet openings 20 in the radial direction.

The filter protective cover 18 comprises a fastening unit 22 for the secure arrangement of the filter element 14 in the filter protective cover 18. The fastening unit 22 is arranged at a further axial end 58 of the filter protective cover 18. The further axial end 58 is arranged on a side of the filter protective cover 18 facing away from the axial end, in particular when viewed along a main extension axis 60 of the filter protective cover 18.

The filter element 14 is detachable, preferably detachable without tools, from the filter protective cover 18, in particular by means of the fastening unit 22 of the filter protective cover 18. The support element 16 can be securely arranged in the filter protective cover 18 by means of the fastening unit 22 of the filter protective cover 18. The fastening unit 22 of the filter protective cover 18 is provided to interact with the support element 16 for the secure arrangement of the filter element 14 in the filter protective cover 18. Alternatively or additionally, it is contemplated that the fastening unit 22 of the filter protective cover 18 is configured to directly interact with the filter element 14 for the secure arrangement of the filter element 14 in the filter protective cover 18.

The filter element 14 is securely arranged in the filter protective cover 18 by means of the fastening unit 22 of the filter protective cover 18 by means of a screw connection (see FIG. 3). Alternatively, however, it is also conceivable that the filter element 14 can be securely arranged in the filter protection cover 18 by means of the fastening unit 22, by means of a latching connection, a screw connection, a clamp connection, or the like. The fastening unit 22 of the filter protective cover 18 comprises a thread 42, in particular an internal thread.

The support element 16 comprises a mounting interface 40 for fastening to, in particular in, the filter protective cover 18. The mounting interface 40 of the support element 16 is provided to interact with the fastening unit 22 of the filter protective cover 18 for the secure arrangement of the filter element 14 and/or the support element 16 on, preferably in, the filter protective cover 18. The mounting interface 40 of the support element 16 is configured corresponding to the fastening unit 22 of the filter protective cover 18. The mounting interface 40 of the support element 16 comprises a thread 44, in particular an external thread. The thread 44 of the mounting interface 40 of the support element 16 is provided to interact with the thread 42 of the fastening unit 22 of the filter protective cover 18 in order to securely arrange the filter element 14 and/or the support element 16 in the filter protective cover 18.

In this example, the support element 16 has six support struts 26 (see FIG. 6). Alternatively, however, it is also conceivable that the support element 16 has one of six different number of support struts 26, for example one support strut 26, two support struts 26, three support struts 26, four support struts 26, five support struts 26, or more than six support struts 26. The support struts 26 are tapered in a respective radial direction, in particular with respect to a main extension axis 46 of the support element 16. The support struts 26 are tapered laterally in the radial direction, preferably on both sides, with regard to their respective main extension axis 48.

The main extension axis 46 of the support element 16 runs at least in the mounted state of the support element 16 at least substantially parallel to the main extension axis 60 of the filter protective cover 18.

The support struts 26 are evenly arranged in the circumferential direction, which runs in particular in a plane perpendicular to the longitudinal direction 24 and/or the main axis of extension 46, of the support element 16. A respective main extension axis 48 (only the main extension axis 48 of one of the support struts 26 is provided with a reference number in FIG. 4) of the support struts 26 runs at least substantially parallel to the longitudinal direction 24 and/or the main extension axis 46 of the support element 16. The main extension axis 46 of the support element 16 runs at least substantially parallel to the longitudinal direction 24 of the support element 16.

The support element 16 is rigid at least in the longitudinal direction 24 (see FIG. 5). The support element 16 is configured such that the support element 16 is free of deformation in the longitudinal direction 24 in an operating state.

The filter protective cover 18 has air guide elements 28 configured as indentations (only one of the air guide elements 28 is provided with a reference number in FIG. 5). The air guide elements 28 are provided to direct an air flow towards the air outlet openings 20 of the filter protective cover 18. An inner wall 50 of the filter protective cover 18 comprises the air guide elements 28 configured as indentations. Alternatively or additionally, it is also conceivable that the filter protective cover 18 comprises at least one air guide element 28 configured as a protrusion.

At least the filter element 14 is arranged spaced apart from the filter protective cover 18 at least to a large extent in a state of the filter element 14 arranged in the filter protective cover 18. In particular, the entire filter element 14 is arranged spaced apart from the filter protective cover 18 when the filter element is arranged in the filter protective cover.

The support element 18 is movable and/or deformable in the mounted state relative to the filter protective cover 18 to generate impacts. The support element 16 has a free end 62 when fastened in the filter protective cover 18. The free end 62 is arranged, in particular at least in an unloaded state of the support element 16, preferably spaced apart from the filter protective cover 18. The free end 62 is movable relative to the filter protective cover 18, for example by shaking the filter protective cover 18. The free end 62 is movable relative to the filter protective cover 18 such that a portion of the filter element 14 arranged on the free end 62 of the support element 16 abuts the filter protective cover 18. The support element 16 is configured to be deflectable in a radial direction, preferably elastically. The filter element 14 has a protrusion relative to the free end 62. Alternatively, however, it is also conceivable that the filter element 14 is free from a protrusion relative to the free end 62.

The filter element 14 comprises a dust-repellent coating 30. The filter element 14 comprises a dust-repellent coating 30 on at least one inner side. For example, the dust-repellent coating 30 may be a polytetrafluorethylene coating, a polyether ether ketone coating, a polymethylurea coating, a nanofiber coating, a combination thereof, or the like. The dust-repellent coating 30 is provided to counteract dust, or the like, sticking on the filter element 14.

The material collection device 10 comprises a cover unit 36. The cover unit 36 comprises a fastening unit 32 for fastening the support element 16. The fastening unit 32 is configured here as a stop element, for example. Preferably, the stop element abuts the support element 16 at least in one operating state. The stop element is provided in particular for a, in particular additional axial, fixation of the support element 16 to the filter protective cover 18.

The cover unit 36 comprises a mounting interface 34 for fastening the filter protective cover 18. The mounting interface 34 is configured as a thread, in particular as an external thread, as way of example. The mounting interface 34 is provided to interact with the fastening unit 22 of the filter protective cover, preferably with the thread 42, to fasten the cover unit 36 to the filter protective cover 18. Alternatively or additionally, however, it is also conceivable that the cover unit 36 can be fastened to the filter protective cover 18 by means of the mounting interface by means of a latching connection, a clamp connection, or the like.

The cover unit 36 comprises a further mounting interface 68 for the detachable, in particular tool-free detachable, fastening of a material disposal unit (not shown here). The further mounting interface 68 is provided to fasten the material disposal unit to the cover unit 36 instead of the filter protective cover 18. The further mounting interface 68 herein has two latch recesses 94, for example, for establishing a latching connection with the material disposal unit.

For example, the material disposal unit is a material collection container having at least one counter-interface compatible with the further mounting interface 68 of the cover unit 36, in particular instead of a counter-interface compatible with the mounting interface 34 of the cover unit 36. For example, the material disposal unit can comprise a hose, in particular at least one hose nozzle, in particular configured as a vacuum cleaner having a counter-interface compatible with the further mounting interface 68, in particular instead of a counter-interface compatible with the mounting interface 34.

The cover unit 36 is provided for a rigid connection of the machine tool 12 to the filter protective cover 18 or the material disposal unit, in particular at least a hose of the material disposal unit, in particular for an automatic entrainment of the filter protective cover 18 or the material disposal unit, in particular at least a hose of the material disposal unit, during a movement of the machine tool 12.

The cover unit 36 comprises a machine tool interface 64 for fastening to the machine tool 12, in particular an ejection port 66 of the machine tool 12. The cover unit 36 is provided to guide the material along an intended trajectory from the machine tool 12 fastened to the cover unit 36 by means of the machine tool interface 64, in particular the ejection port 66, to the filter protection cover 18 fastened to the cover unit 36 by means of the mounting interface 34 or to the material disposal unit fastened to the cover unit 36 by means of the further mounting interface 68 of the cover unit 36. Along the provided trajectory, the cover unit 36 comprises an inlet opening 70 for receiving the material from the machine tool 12 and an outlet opening 72 for ejecting the material from the cover unit 36, in particular into the filter protective cover 18 or into the material disposal unit.

The cover unit 36 preferably comprises an, in particular annular, central wall 74, which bounds the outlet opening 72. The cover unit 36 comprises an outlet center axis 76, which stands in particular perpendicularly on an outlet opening 72 of the cover unit 36, through which the material exits the cover unit 36. The outlet center axis 76 passes through a geometrical center of gravity of the central wall 74.

The cover unit 36 comprises at least one fixation wall portion 78 arranged on the central wall 74, on which the mounting interface 34 of the cover unit 36 is arranged. The cover unit 36 comprises at least one further fixation wall portion 80 arranged on the central wall 74, on which the further mounting interface 68 is arranged. The cover unit 36 comprises at least one machine tool-side wall portion 82 arranged on the central wall 74, on which the machine tool interface 64 is arranged.

The cover unit 36 in particular has an opening plane, which preferably runs perpendicular to the outlet center axis 76. The opening plane limits an axial extension of the further fixation wall portion 80.

The further fixation wall portion 80 forms an air bypass 84 (see FIG. 8). The air bypass 84 is formed by a recess of the further fixation wall portion 80 that differs from the further mounting interface 68. The air bypass 84 and at least a majority of the machine tool interface 64 or the complete machine tool interface 64 are arranged in different halves of the cover unit 36 relative to at least one cutting plane comprising the outlet center axis 76.

The air bypass 84 is formed by at least one, particularly preferably exactly one, slot-shaped air bypass recess 86 of the further fixation wall portion 80. The air bypass recess 86 extends from the opening plane of the cover unit 36, starting at least substantially parallel to the outlet center axis 76. A maximum longitudinal extension of the air bypass recess 86 parallel to the outlet center axis 76 is greater than a maximum opening width of the air bypass recess 86 in a plane perpendicular to the outlet center axis 76. A maximum longitudinal extension of the air bypass recess 86 extends parallel to the outlet center axis 76 over at least a substantial proportion of a parallel maximum longitudinal extension of the further fixation wall portion 80. The air bypass recess 86 has an opening width of less than 60°, preferably less than 45°, particularly preferably less than 35° in a plane perpendicular to the outlet center axis 76 with respect to the outlet center axis 76. The air bypass recess 86 has an opening width of greater than 25°, preferably greater than 20°, particularly preferably greater than 15° in a plane perpendicular to the outlet center axis 76 with respect to the outlet center axis 76.

The machine tool interface 64 comprises a base body made of a base material. The base body is formed integrally with the machine tool-side wall portion 82. The base body comprises a hollow cylindrical connector element, in particular for receiving the ejection port 66 of the machine tool 12. The machine tool interface 64 comprises at least one fastening element 88 arranged on the base body made of an in particular thermoplastic elastomeric material that is different from the base material.

The fastening element 88 forms a substantially circumferentially closed inner lining of the base body, in particular of the connector element. The fastening element 88 preferably forms a sleeve that is arranged within the connector element. For example, the fastening element 88 forms an anchor arranged on the sleeve, which projects out of the connector element and is arranged in particular on an outer wall of the machine tool-side wall portion 82, in particular in a positive locking manner. The fastening element 88 is preferably arranged on the base body by over-molding the base body.

The machine tool interface 64 comprises at least one contact element 90, 92 made of an electrically conductive material, in particular a carbon fiber-reinforced plastic, for dissipating an electrostatic charge (see FIG. 7). The at least one contact element 90, 92 is preferably formed in a rod-like fashion. The contact element 90, 92 preferably projects out of an inner wall of the base body. Preferably, the at least one contact element 90, 92 is configured integrally with the base body. Preferably, a base material from which the base body is manufactured is equal to the electrically conductive material, in particular the carbon fiber-reinforced plastic, of the at least one contact element 90, 92. As a result, an electrical charge can advantageously in particular be passed or dissipated to a vacuum cleaner hose via the further mounting interface 34. The fastening element 88 preferably has at least one recess through which the contact element 90, 92 projects or is made accessible for direct physical contact with the machine tool 12.

1. A material collection device for a machine tool, comprising:
at least one filter element;
a support element arranged in a mounted state within the at least one filter element, the support element configured to clamp the filter element; and
a filter protective cover defining at least one air outlet opening,
wherein the at least one filter element is arranged in the filter protective cover in the mounted state.

2. The material collection device according to claim 1, wherein the filter protective cover comprises a fastening unit for the secure arrangement of the at least one filter element in the filter protective cover.

3. The material collection device according to claim 1, wherein the support element is rigid at least in a longitudinal direction.

4. The material collection device according to claim 1, wherein the support element comprises at least one support strut, which is tapered in a radial direction.

5. The material collection device according to claim 1, wherein the filter protective cover comprises at least one air guide element configured as a recess.

6. The material collection device according to claim 1, wherein the at least one filter element is spaced apart from the filter protective cover at least to a large extent in a state of the at least one filter element arranged in the filter protective cover.

7. The material collection device according to claim 1, wherein the support element in the mounted state is movable and/or deformable relative to the filter protective cover to generate impacts.

8. The material collection device according to claim 1, wherein the at least one filter element comprises a dust-repellent coating.

9. A support element for a filter element of a material collection device according to claim 1, for a machine tool, comprising:
a fastening unit configured to fasten the filter element; and
a mounting interface configured to fasten to a filter protective cover of the material collection device.

10. A cover unit for a material collection device according to claim 1, for a machine tool, comprising:
a fastening unit configured to fasten a support element for a filter element; and
a mounting interface configured to fasten to a filter protective cover.

11. A machine tool, comprising:
a material collection device according to claim 1.
